(19) United States
(12) Patent Application Publication
(10) Pub. No.: US 2026/0128585 A1
(43) Pub. Date: May 7, 2026

(54) ENERGY STORAGE APPARATUS

(71) Applicant: GS Yuasa International Ltd., Kyoto-shi (JP)

(72) Inventors: Ryuichi ITO, Kyoto-shi (JP); Shoichi ARIMOTO, Kyoto-shi (JP); Shota OKAMOTO, Kyoto-shi (JP)

(21) Appl. No.: 19/425,349

(22) Filed: Dec. 18, 2025

Related U.S. Application Data
(63) Continuation of application No. PCT/JP2024/021958, filed on Jun. 18, 2024.

(30) Foreign Application Priority Data
Jun. 20, 2023 (JP) 2023-100576

(51) Int. Cl. H02H 11/00; H01M 10/42; H02H 7/18

(52) U.S. Cl. CPC H02H 11/002; H01M 10/425; H02H 7/18; H01M 2010/4271

(57) ABSTRACT

An energy storage apparatus includes a first semiconductor switch and a second semiconductor switch provided in series on a power line between an energy storage device and a negative terminal, a cutoff control switch connected to the first and second semiconductor switches to simultaneously turn off the first and second semiconductor switches when an abnormality of the energy storage device is detected by a management controller, and an external charge detector to simultaneously turn on the first and second semiconductor switches when detecting that an external power supply has been connected to a positive terminal and the negative terminal.

### CROSS REFERENCE TO RELATED APPLICATIONS

This application claims the benefit of priority to Japanese Patent Application No. 2023-100576 filed on Jun. 20, 2023 and is a Continuation Application of PCT Application No. PCT/JP2024/021958 filed on Jun. 18, 2024. The entire contents of each application are hereby incorporated herein by reference.

### BACKGROUND OF THE INVENTION

### 1. Field of the Invention

The present invention relates to energy storage apparatuses.

### 2. Description of the Related Art

Generally, in motorcycles, a lead battery is used as an energy storage apparatus for starting an engine of the motorcycle. However, in Japanese Unexamined Patent Application Publication No. 2020-167766, an energy storage apparatus including a plurality of lithium-ion secondary batteries (energy storage devices) is applied to a motorcycle.

In Japanese Unexamined Patent Application Publication No. 2020-167766, as a circuit breaker for protection of the energy storage devices, a field-effect transistor (FET) is provided between a negative electrode of the energy storage device and a negative terminal of the energy storage apparatus (that is, on a low side of the energy storage device). The FET is turned off (opened) when an abnormal event of the energy storage devices, such as overcharge or overcurrent, occurs.

### SUMMARY OF THE INVENTION

Example embodiments of the present invention provide energy storage apparatuses each capable of preventing thermal destruction of a semiconductor switch provided on a low side of a power line, and for which restoration of operation or prohibition of the restoration of operation can be implemented after the switch is turned off.

An energy storage apparatus according to an example embodiment of the present invention includes an energy storage device, a management controller, a positive terminal and a negative terminal, a power line connecting the positive terminal, the energy storage device, and the negative terminal to each other, a first semiconductor switch and a second semiconductor switch provided in series on the power line between the energy storage device and the negative terminal, a cutoff control switch connected to the first and second semiconductor switches to simultaneously turn off the first and second semiconductor switches when an abnormality of the energy storage device is detected by the management controller, and an external charge detector to simultaneously turn on the first and second semiconductor switches when detecting that an external power supply has been connected to the positive terminal and the negative terminal.

An energy storage apparatus according to another example embodiment of the present invention includes an energy storage device, a management controller, a positive terminal and a negative terminal, a power line connecting the positive terminal, the energy storage device, and the negative terminal to each other, a first semiconductor switch and a second semiconductor switch provided in series on the power line between the energy storage device and the negative terminal, a cutoff control switch connected to the first and second semiconductor switches to simultaneously turn off the first and second semiconductor switches when a first abnormality of the energy storage device is detected by the management controller, a latch circuit, and a reuse prohibition switch provided in series with the cutoff control switch to be turned off by the latch circuit when a second abnormality of the energy storage device is detected by the management controller and to maintain an off state even when the second abnormality is resolved.

An energy storage apparatus according to yet another example embodiment of the present invention includes an energy storage device, a management controller, a positive terminal and a negative terminal, a power line connecting the positive terminal, the energy storage device, and the negative terminal to each other, a first semiconductor switch and a second semiconductor switch provided in series on the power line between the energy storage device and the negative terminal, a cutoff control switch connected to the first and second semiconductor switches to simultaneously turn off the first and second semiconductor switches when an abnormality of the energy storage device is detected by the management controller, a latch circuit, and a reuse prohibition switch provided in series with the cutoff control switch to be turned off by the latch circuit when the abnormality of the energy storage device is detected by the management controller and to maintain an off state even when the abnormality is resolved.

According to the above example embodiments, it is possible to provide energy storage apparatuses each capable of preventing thermal destruction of the first and second semiconductor switches provided on the power line by simultaneously turning off the first and second semiconductor switches, and for which restoration of operation or prohibition of the restoration of operation can be implemented after the switches are turned off.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of a motorcycle.

FIG. 2 is a block diagram of a vehicle system.

FIG. 3 is an exploded perspective view illustrating a configuration example of an energy storage apparatus.

FIG. 4 is an electrical block diagram illustrating a configuration example of an energy storage apparatus.

FIG. 5 is a diagram for describing a circuit operation of a case where a low voltage abnormality of an energy storage apparatus is detected.

FIG. 6 is a diagram for describing a pull-up operation for pulling up a potential of a negative terminal.

FIG. 7 is a diagram for describing a circuit operation of a case where a charger is connected after a low voltage abnormality has occurred.

FIG. 8 is a diagram for describing a circuit operation of a case where an overcharge abnormality of an energy storage apparatus is detected.

FIG. 9 is a diagram for describing a state of each portion according to the state of the energy storage apparatus.

FIG. 10 is a diagram illustrating a case of an external short circuit which has occurred in a state in which a charge cutoff FET is turned off and a discharge cutoff FET is kept turned on in order to protect an energy storage device from being overcharged.

### DETAILED DESCRIPTION OF THE EXAMPLE EMBODIMENTS

In the following, an outline of example embodiments will be described.

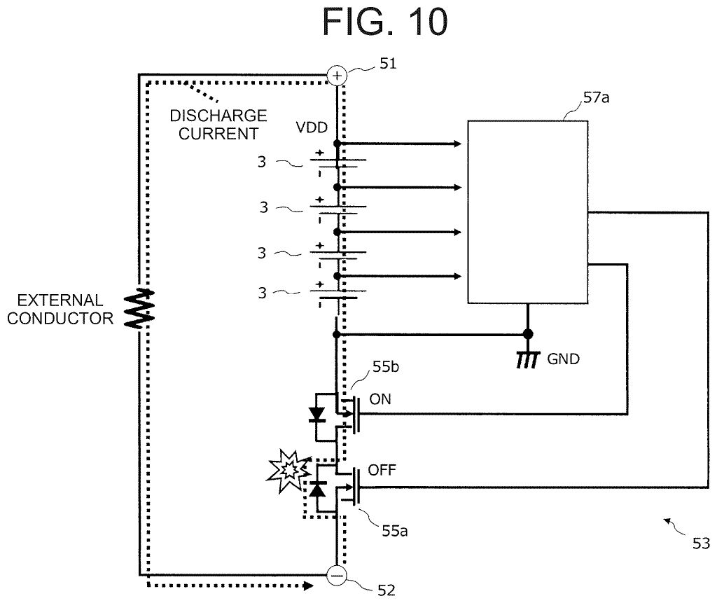

In order to reduce the number of booster circuits (charge pump circuits and switching regulator circuits) for gate voltage generation of an N-channel FET, the inventors of example embodiments of the present invention have considered arranging the N-channel FET on a low side of an energy storage device 3, as illustrated in FIG. 10.

Alternatively, while a P-channel FET may be arranged on a high side of the energy storage device 3, an on-resistance of the P-channel FET is higher than that of the N-channel FET. For this reason, in order to ensure a current-carrying capability equivalent to that of the N-channel FET, it is necessary to increase the number of P-channel FETs connected in parallel, which means that a board size is increased and a cost is increased.

In the example of an energy storage apparatus of FIG. 10, a management controller 53 includes a discharge cutoff FET 55b and a charge cutoff FET 55a, which are connected in series such that directions of parasitic diodes (body diodes) of these FETs are opposite to each other, and a battery monitoring IC (integrated circuit) 57a.

In order to protect the energy storage device 3 from being overcharged, the battery monitoring IC 57a causes the charge cutoff FET 55a to be turned off and the discharge cutoff FET 55b to be kept turned on. By virtue of the turned-off charge cutoff FET 55a, a charge of the energy storage device 3 is prohibited (i.e., the parasitic diode incorporated therein blocks a charging current), but a discharge of the energy storage device 3 via the parasitic diode is permitted. In this state, when a positive terminal 51 and a negative terminal 52 of the energy storage apparatus are short-circuited via an external conductor (externally short-circuited), a large current (a discharge current) indicated by a broken line flows through the parasitic diode of the charge cutoff FET 55a. Consequently, there is a possibility that the charge cutoff FET 55a may be thermally destructed by a temperature rise caused by a power loss in the parasitic diode.

Although not illustrated, in order to protect the energy storage device from being over-discharged, the battery monitoring IC 57a causes the discharge cutoff FET 55b to be turned off and the charge cutoff FET 55a to be kept turned on. By virtue of the turned-off discharge cutoff FET 55b, a discharge of the energy storage device 3 is prohibited (i.e., the parasitic diode incorporated therein blocks a discharge current), but a charge of the energy storage device 3 via the parasitic diode is permitted. In this state, when the positive terminal 51 and the negative terminal 52 of the energy storage apparatus are connected to another vehicle (battery) via a booster cable and a jump start is attempted, a large current (a charging current) flows through the parasitic diode of the discharge cutoff FET 55b. Consequently, there is a possibility that the discharge cutoff FET 55b may be thermally destructed by a temperature rise caused by a power loss in the parasitic diode.

Therefore, the inventors of the present invention have conceived the following configuration.

(1) An energy storage apparatus includes an energy storage device, a management controller, a positive terminal (a positive external terminal) and a negative terminal (a negative external terminal), a power line connecting the positive terminal, the energy storage device, and the negative terminal to each other, a first semiconductor switch and a second semiconductor switch provided in series on the power line between the energy storage device and the negative terminal, a cutoff control switch connected to the first and second semiconductor switches to simultaneously turn off the first and second semiconductor switches when an abnormality of the energy storage device is detected by the management controller, and an external charge detector to simultaneously turn on the first and second semiconductor switches when detecting that an external power supply has been connected to the positive terminal and the negative terminal.

Here, the “semiconductor switch” may be a metal-oxide-semiconductor (MOS) FET, but is not limited to this form. The semiconductor switch may be a bipolar transistor, an Insulated Gate Bipolar Transistor (IGBT), or a gallium nitride (GaN) heterojunction transistor.

From the standpoint of a balance between performance and the cost, N-channel MOSFETs can be used as the first and second semiconductor switches.

The “cutoff control switch” may be a P-channel MOSFET, but is not limited to this form. The cutoff control switch may be included in the management controller, or may be provided on a circuit board constituting the management controller.

The “external charge detector” may be included in the management controller, or may be provided on the circuit board constituting the management controller.

The “power line” and the “first semiconductor switch and second semiconductor switch” may also be provided on the circuit board constituting the management controller.

According to the energy storage apparatus of (1) described above, it is possible to prevent thermal destruction of the first and second semiconductor switches provided on the power line by simultaneously turning off the first and second semiconductor switches. That is, by simultaneously turning off the first and second semiconductor switches, it is possible to prevent thermal destruction of the switch due to a large current flowing through a parasitic diode of one of the semiconductor switches.

When the first and second semiconductor switches are turned off, a ground (GND) of the management controller of the energy storage apparatus is disconnected from the negative terminal, so that a GND potential of the management controller floats. In such a state, even if an external power supply such as a charger is connected to the positive terminal and the negative terminal, the management controller of the energy storage apparatus cannot clearly recognize a difference between the potential of the positive terminal and the GND potential. Thus, the management controller of the energy storage apparatus cannot detect that the external power supply has been connected. This is an event which occurs when the first semiconductor switch and the second semiconductor switch, which are provided in series on the low side of the energy storage device, are both turned off simultaneously.

According to the energy storage apparatus of (1) described above, it is possible to use the external charge detector to detect that an external power supply has been connected and simultaneously turn on the first and second semiconductor switches. Therefore, after the first and second semiconductor switches are turned off, the operation (charging and discharging) of the energy storage apparatus can be restored by the connection of the external power supply.

The management controller and the external charge detector can be configured by a hardware circuit which operates according to the state (for example, a potential) of each portion (a terminal of a switch or the like) of the energy storage apparatus, in other words, a circuit which does not require software or a central processing unit (CPU). As the hardware circuit is adopted, it is possible to avoid an increase in the cost due to the use of a CPU (for example, a microcomputer).

(2) An energy storage apparatus includes an energy storage device, a management controller, a positive terminal and a negative terminal, a power line connecting the positive terminal, the energy storage device, and the negative terminal to each other, a first semiconductor switch and a second semiconductor switch provided in series on the power line between the energy storage device and the negative terminal, a cutoff control switch connected to the first and second semiconductor switches to simultaneously turn off the first and second semiconductor switches when a first abnormality of the energy storage device is detected by the management controller, a latch circuit, and a reuse prohibition switch provided in series with the cutoff control switch to be turned off by the latch circuit when a second abnormality of the energy storage device is detected by the management controller and to maintain an off state even when the second abnormality is resolved.

Here, the “second abnormality” may be an abnormal event whose impact on the energy storage device is larger than that of the “first abnormality” should the abnormality occur. Examples of the second abnormality include a deep discharge (i.e., a discharge to a state in which the state of charge (SOC) of the energy storage device is lower than 0%) and an overcharge. Examples of the first abnormality include minor abnormalities such as a low voltage abnormality and a discharge overcurrent abnormality.

According to the energy storage apparatus of (2) described above, it is possible to prevent thermal destruction of the first and second semiconductor switches provided on the power line by simultaneously turning off the first and second semiconductor switches. That is, by simultaneously turning off the first and second semiconductor switches, it is possible to prevent thermal destruction of the switch due to a large current flowing through a parasitic diode of one of the semiconductor switches.

The cutoff control switch, which is a switch to simultaneously turn off both the first semiconductor switch and the second semiconductor switch provided in series on the low side of the energy storage device, alone cannot realize prohibition of the operation restoration of the energy storage apparatus. Depending on the specifications of a battery monitoring IC to be described later, there is a case where the operation (charging and discharging) of the energy storage apparatus can be restored as a result of the voltage of the energy storage device being reduced to a normal level after a protective function against an overcharge, which corresponds to the “second abnormality”, is exhibited.

According to the energy storage apparatus of (2) described above, by latching the reuse prohibition switch provided in series with the cutoff control switch in a state of being turned off, prohibition of the operation restoration of the energy storage apparatus can be realized. By adopting the reuse prohibition switch which can be switched by the management controller instead of a component which melts down such as a fuse, operation confirmation of the reuse prohibition can be carried out in a manufacturing process.

The management controller can be configured by a hardware circuit which operates according to the state of each portion of the energy storage apparatus. As the hardware circuit is adopted, it is possible to avoid an increase in the cost due to the use of a CPU.

(3) The energy storage apparatus according to (1) described above may further include a wiring line provided in parallel with the power line to connect the power line, which is between the positive terminal and the energy storage device, and the negative terminal to each other, and a third semiconductor switch on the wiring line.

According to the above configuration, at the time when the first and second semiconductor switches are turned off, the third semiconductor switch is turned on, and a potential of the negative terminal of the energy storage apparatus is pulled up and stabilized. As a consequence, connection of an external power supply can be detected reliably.

(4) In the energy storage apparatus according to (3) described above, the external charge detector may include an operation restoration switch and a first push-pull circuit to which a potential of the negative terminal is input, and the operation restoration switch may be switched by an output of the first push-pull circuit to cause the first and second semiconductor switches to be simultaneously turned on.

According to the above configuration, while avoiding an increase in the cost due to the use of a CPU, a highly reliable external charge detector can be configured by a simple hardware circuit.

(5) The energy storage apparatus according to (4) described above may further include a delay circuit to cause a timing at which the operation restoration switch is set to a standby state to be more delayed than a timing at which the potential of the negative terminal is pulled up.

According to the above configuration, the operation restoration switch is set to the standby state in consideration of the delay in time required to pull up the potential of the negative terminal. In this way, it is possible to prevent the management controller from erroneously detecting a remaining capacity (an electric charge) of a vehicle as being an external charge, and to certainly turn off the first semiconductor switch and the second semiconductor switch. Thus, reliability of the energy storage apparatus can be improved.

(6) The energy storage apparatus according to (4) or (5) described above may further include a second push-pull circuit to which an output of the delay circuit is to be input, and the operation restoration switch may be set to a standby state or switching of the operation restoration switch may be prohibited depending on an output of the second push-pull circuit.

According to the above configuration, while avoiding an increase in the cost due to the use of a CPU, the external charge detector and a restoration function enabling portion, which will be described later, can be configured by a simple hardware circuit.

(7) An energy storage apparatus includes an energy storage device, a management controller, a positive terminal and a negative terminal, a power line connecting the positive terminal, the energy storage device, and the negative terminal to each other, a first semiconductor switch and a second semiconductor switch provided in series on the power line between the energy storage device and the negative terminal, a cutoff control switch connected to the first and second semiconductor switches to simultaneously turn off the first and second semiconductor switches when an abnormality of the energy storage device is detected by the management controller, a latch circuit, and a reuse prohibition switch provided in series with the cutoff control switch to be turned off by the latch circuit when the abnormality of the energy storage device is detected by the management controller and to maintain an off state even when the abnormality is resolved.

According to the above configuration, when, for example, an overcharge is detected as an abnormality, the energy storage apparatus can quickly transition to a switch-off mode in which restoring the operation of the energy storage apparatus is prohibited without undergoing a switch-off mode in which restoring the operation of the energy storage apparatus is permitted.

In the following, specific explanation will be given by referring to the drawings indicating the example embodiments.

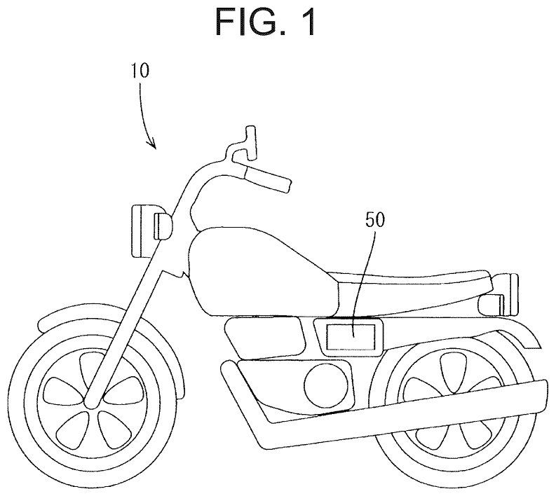

As illustrated in FIG. 1, a battery 50 (an example of the energy storage apparatus) according to an example embodiment is a two-wheeled vehicle battery which is mounted on a motorcycle 10. The battery 50 is rated at 12 volts (V), which allows the battery 50 to be replaced (e.g., retrofitted) from a conventional lead battery.

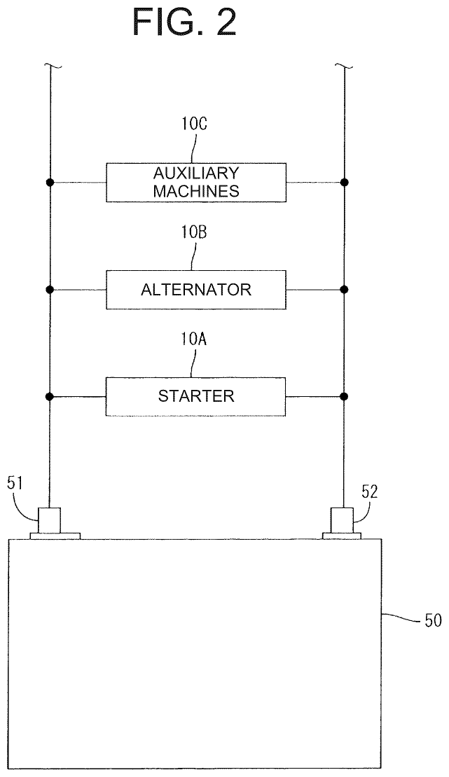

As illustrated in FIG. 2, a starter 10A, an alternator 10B (an example of a vehicular battery charger), and auxiliary machines 10C (a headlight, a car navigation system, and the like), which are mounted on the motorcycle 10, are connected to the battery 50. The battery 50 supplies electric power of 12 V to the starter 10A to start an engine (an internal-combustion engine). The battery 50 is charged by the alternator 10B when the engine is being operated.

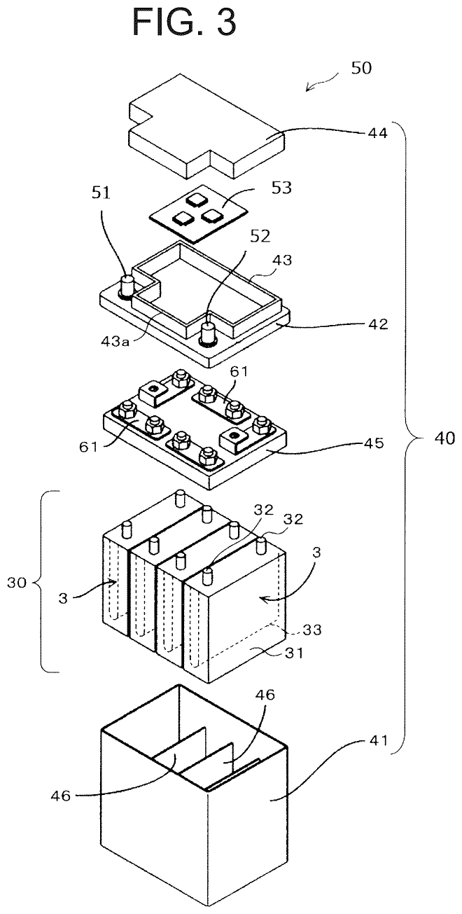

As illustrated in FIG. 3, the battery 50 includes: the management controller 53; a plurality of energy storage cells 3 (an example of the energy storage devices); and an accommodating case 40 having a rectangular parallelepiped shape in which the management controller 53 and the plurality of energy storage cells 3 are accommodated. The energy storage cell 3 may be a battery cell such as a lithium-ion secondary battery, or an electrochemical cell such as a capacitor. The management controller 53 is a battery management controller (BMU) in the present example embodiment.

Four energy storage cells 3 are connected in series to constitute an assembled battery 30 (another example of the energy storage device). Alternatively, some of these energy storage cells 3 may be connected in parallel. For example, the assembled battery 30 may include eight energy storage cells 3 connected in a two-parallel and four-series configuration, or may include twelve energy storage cells 3 connected in a three-parallel and four-series configuration.

The accommodating case 40 is made of a synthetic resin. The accommodating case 40 includes: a case main body 41; a lid portion 42 which closes an opening portion of the case main body 41; an accommodating portion 43 which is provided on the lid portion 42; a cover 44 which covers the accommodating portion 43; an inner lid (a bus bar frame) 45; and a partition plate 46. The inner lid 45 and the partition plate 46 may not be provided. The energy storage cell 3 is inserted between the partition plates 46 of the case main body 41.

A plurality of metallic bus bars 61 (conductive members) are placed on the inner lid 45. The inner lid 45 is disposed in the vicinity of a terminal surface where cell terminals 32 of the energy storage cells 3 are provided. Thus, the adjacently arranged cell terminals 32 of the adjacently arranged energy storage cells 3 are connected to each other by the bus bar 61, so that the energy storage cells 3 are connected in series.

The accommodating portion 43 is formed in a box shape, and includes, at a central part of one long side of the accommodating portion 43 in a plan view, a projecting part 43a which projects outward. The positive terminal 51 and the negative terminal 52, which are made of a metal such as a lead alloy, are provided on both sides of the projecting part 43a of the lid portion 42. The BMU 53 is accommodated in the accommodating portion 43. The BMU 53 is connected to the energy storage cells 3 via a wiring member (not shown) and the bus bars 61. Instead of being accommodated in the accommodating portion 43, the BMU 53 may be disposed, for example, upwardly or laterally adjacent to the assembled battery 30. The BMU 53 may include a plurality of circuit boards.

The energy storage cell 3 includes a case 31 having a hollow rectangular parallelepiped shape, and a pair of cell terminals 32 and 32 whose polarities are different that are provided on one side surface (terminal surface, upper surface) of the case 31. In the case 31, an electrode body 33 which is formed by stacking a positive electrode, a separator, and a negative electrode over one another, and an electrolyte (an electrolytic solution) which is not illustrated are accommodated.

Although not illustrated in detail, the electrode body 33 is configured by arranging the positive electrode and the negative electrode, which are sheet-shaped, in an overlapping manner with two sheet-shaped separators being interposed, and then winding (vertically winding or horizontally winding) these elements. The separator is formed of a porous resin film. As the porous resin film, a porous resin film made of a resin such as polyethylene (PE) or polypropylene (PP) can be used.

The positive electrode is an electrode plate in which a positive electrode active material layer is formed on a surface of a long band-shaped positive electrode substrate made of, for example, aluminum, an aluminum alloy, or the like. The positive electrode active material layer includes a positive electrode active material. A material capable of absorbing and releasing lithium ions can be used as the positive electrode active material used in the positive electrode active material layer. As the positive electrode active material, LiFePO₄, for example, is used. However, the positive electrode active material is not limited thereto, and a so-called ternary positive electrode active material may be used. The positive electrode active material layer may further include a conductive auxiliary agent, a binder, and the like.

The negative electrode is an electrode plate in which a negative electrode active material layer is formed on a surface of a long band-shaped negative electrode substrate made of, for example, copper or a copper alloy. The negative electrode active material layer includes a negative electrode active material. As the negative electrode active material, a material capable of absorbing and releasing lithium ions can be used. Examples of the negative electrode active material include graphite, hard carbon, and soft carbon. The negative electrode active material layer may further include a binder, a thickener, and the like.

As the electrolyte accommodated in the accommodating case 40 together with the electrode body 33, an electrolyte similar to that of a conventional lithium-ion secondary battery can be used. For example, as the electrolyte, an electrolyte in which a supporting salt is contained in an organic solvent can be used. As the organic solvent, for example, an aprotic solvent such as carbonates, esters, or ethers is used. As the supporting salt, for example, a lithium salt such as LiPF₆, LiBF₄, or LiClO₄ is suitably used. The electrolyte may include, for example, various additives such as a gas generating agent, a coating film forming agent, a dispersing agent, and a thickener.

FIG. 3 illustrates, as an example of the energy storage cell 3, a square lithium-ion battery including the wound-type electrode body 33. Alternatively, the energy storage cell 3 may be a cylindrical lithium-ion battery or a laminated (pouched) lithium-ion battery. The energy storage cell 3 may be a lithium-ion battery including a stacked-type electrode body. The energy storage cell 3 may be an all-solid-state lithium-ion battery using a solid electrolyte.

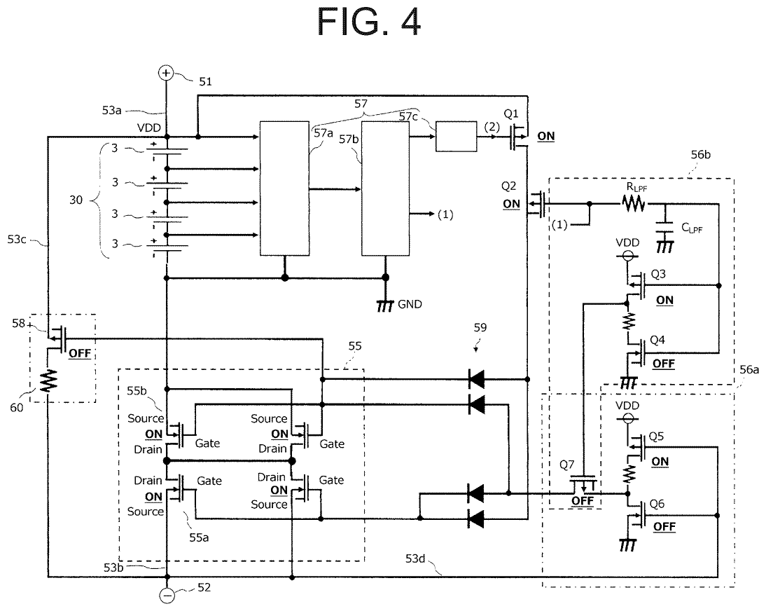

FIG. 4 is an electrical block diagram of the battery 50. The positive terminal 51 and the assembled battery 30 are connected to each other by a power line 53a. Among the four energy storage cells 3 that are connected in series which constitute the assembled battery 30, the energy storage cell which is directly connected to the positive terminal 51 is referred to as a fourth cell. A cell adjacent to the fourth cell is referred to as a third cell, a cell adjacent to the third cell is referred to as a second cell, and a cell adjacent to the second cell is referred to as a first cell. The first cell and the negative terminal 52 are connected to each other by a power line 53b.

At least a part of the power lines 53a and 53b may be constituted by the bus bar 61 (see FIG. 3).

The N-channel FET 55a (a first semiconductor switch) for charge cutoff and the N-channel FET 55b (a second semiconductor switch) for discharge cutoff are provided in series on the power line 53b.

In the present example embodiment, a plurality of FET sets, each including the N-channel FET 55a for charge cutoff and the N-channel FET 55b for discharge cutoff that are provided in series, are provided in parallel with the power line 53b to constitute a cutoff portion 55. A current which flows through the power line 53b is distributed into the plurality of FET sets that are connected in parallel, and is cut off by the plurality of FET sets if an abnormal event occurs.

In the present example embodiment, the N-channel FETs 55a and 55b in each FET set are connected back-to-back with their drain terminals facing inward, i.e., in a drain-common configuration. Alternatively, the FETs 55a and 55b in each FET set may be arranged in an opposite way to the above arrangement so that the FETs 55a and 55b are connected back-to-back in a source-common configuration.

The number of FET sets connected in parallel is set according to the current-carrying capability required for the energy storage apparatus.

The BMU further includes a pull-up wiring line 53c which is provided in parallel with the power lines 53a and 53b, and connects the power line 53a and the negative terminal 52 to each other. A P-channel FET 58 (a third semiconductor switch) and a resistor 60 which serves as a resistance element are provided in series on the pull-up wiring line 53c. The resistance element may be any element as long as it can generate a resistance component to prevent a short circuit between the positive terminal 51 and the negative terminal 52, and may be an inexpensive passive component.

In the present example embodiment, one end of the pull-up wiring line 53c is connected to a point, which is between the positive terminal 51 and the fourth cell, of the power line 53a, and an other end of the pull-up wiring line 53c is connected to a point, which is between the cutoff portion 55 and the negative terminal 52, of the power line 53b. Since the one end is connected to the point on the power line 53a between the positive terminal 51 and the fourth cell, it is possible to secure a gate-source voltage capable of turning on the P-channel FET 58 even in a state in which cell voltages (V_{cell}1, V_{cell}2, V_{cell}3, and V_{cell}4) of the respective energy storage cells 3 are lowered.

The pull-up wiring line 53c, the P-channel FET 58, and the resistor 60 perform a plurality of functions such as the function of discharging a vehicle-side electric charge (function as a vehicle capacitance discharge circuit), which will be described later, and the function as a part of an external charge detector 56a.

The BMU includes the battery monitoring IC 57a, a cutoff control circuit 57b, and a latch circuit 57c, and these elements constitute a control portion 57 as a hardware circuit which does not use a CPU. The BMU further includes a reuse prohibition switch Q1 and a cutoff control switch Q2 which are P-channel FETs, the external charge detector 56a, a restoration function enabling portion 56b, and a diode 59.

The battery monitoring IC 57a monitors the state of each cell (for example, the cell voltage), and outputs an abnormality signal to the cutoff control circuit 57b when detecting an abnormality of the battery.

In response to the signal from the battery monitoring IC 57a, the cutoff control circuit 57b outputs a low or high signal (1), and the latch circuit 57c which receives the signal from the cutoff control circuit 57b outputs a low or high signal (2).

First, with reference to FIG. 4, a circuit operation at a normal time at which no abnormality, such as an overcharge or an over-discharge, has occurred will be described. At the normal time, there is no occurrence of a battery abnormality, and thus, the cutoff control circuit 57b outputs a low (GND) signal as the signal (1), and the latch circuit 57c outputs a low signal as the signal (2). At this time, the reuse prohibition switch Q1 whose source receives an input of a potential of a positive terminal of the fourth cell, i.e., a positive potential (VDD) of the assembled battery 30, and the cutoff control switch Q2 whose source is connected to a drain of the reuse prohibition switch Q1 are both turned on. As a result, a high signal is input to a gate of each of the FETs 55a, 55b, and 58 from a drain of the cutoff control switch Q2 via the diodes 59, and the N-channel FETs 55a and 55b of the cutoff portion 55 are turned on. Thus, the energy storage apparatus can be charged and discharged. The P-channel FET 58 of the pull-up wiring line 53c is turned off.

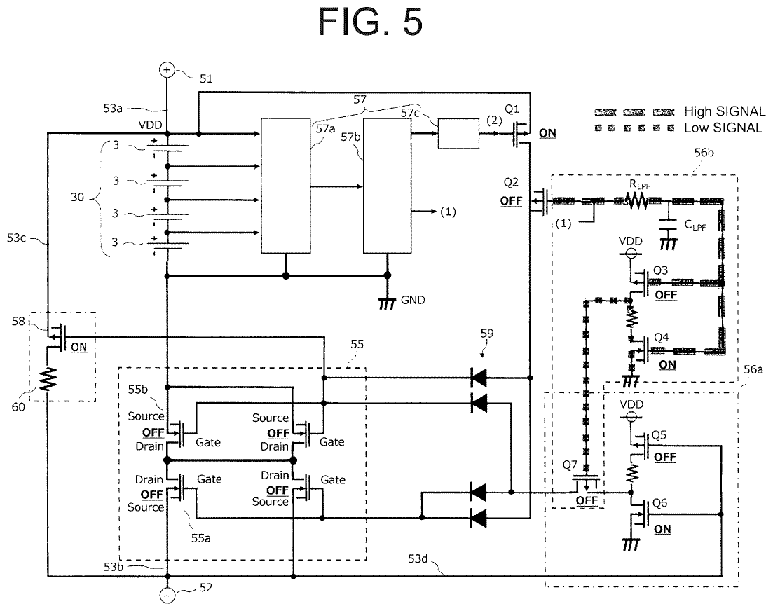

Next, with reference to FIG. 5, a circuit operation of a case where a low voltage abnormality has occurred will be described. In this case, a signal indicating a low voltage abnormality is output from the battery monitoring IC 57a, and the cutoff control circuit 57b outputs a high (VDD) signal as the signal (1). As a result, the gate-source voltage of the cutoff control switch Q2 becomes substantially zero volts, and the switch Q2 is turned off, so that the N-channel FETs 55a and 55b of the cutoff portion 55 are also turned off. The P-channel FET 58 of the pull-up wiring line 53c is turned on, and a pull-up of the potential of the negative terminal 52 is started.

The restoration function enabling portion 56b includes a push-pull circuit (a second push-pull circuit) including a switch Q3, which is a P-channel FET, and a switch Q4, which is an N-channel FET. A high signal is input to the push-pull circuit as the signal (1), and the switch Q3 is turned off and the switch Q4 is turned on. Then, a ground (GND) signal is output from the push-pull circuit and input to a gate of an operation restoration switch Q7, which is a P-channel FET.

The operation restoration switch Q7 constitutes a part of the restoration function enabling portion 56b and also constitutes a part of the external charge detector 56a.

The external charge detector 56a includes a push-pull circuit (a first push-pull circuit) including a switch Q5, which is a P-channel FET, and a switch Q6, which is an N-channel FET.

An output (VDD or GND) of the push-pull circuit of the external charge detector 56a is input to a source of the operation restoration switch Q7. A drain of the operation restoration switch Q7 is connected to the gate of each of the FETs 55a and 55b of the cutoff portion 55 and the gate of the FET 58 via the diodes 59.

As described above, the GND signal output from the push-pull circuit of the restoration function enabling portion 56b is input to the gate of the operation restoration switch Q7, and the operation restoration switch Q7 is set to a standby state (a restoration function enabled state). The standby state is intended as a state in which the N-channel FETs 55a and 55b of the cutoff portion 55 can be turned on again if a voltage (VDD) is applied to the source of the operation restoration switch Q7.

The potential of the negative terminal 52 is pulled up to VDD, and thus, in the push-pull circuit constituted by the switches Q5 and Q6 of the external charge detector 56a, the switch Q5 is turned off and the switch Q6 is turned on, as illustrated in FIG. 5. Therefore, GND is input to the source of the operation restoration switch Q7 as the output of the push-pull circuit, and the operation restoration switch Q7 maintains the standby state.

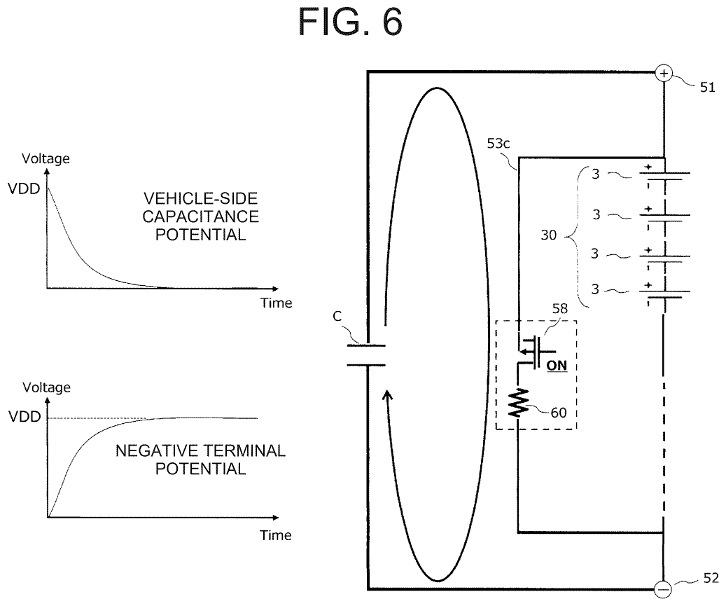

At the time immediately after the FETs 55a and 55b of the cutoff portion 55 on the power line 53b are turned off, as indicated by a graph at the upper left of FIG. 6, an electric charge remains in a vehicle on which the energy storage apparatus is mounted. The pull-up wiring line 53c, the P-channel FET 58, and the resistor 60 perform the function of extracting (consuming) the electric charge on the vehicle side. The potential of the negative terminal 52 is gradually pulled up to VDD in inverse proportion to a decrease in the potential of a vehicle-side capacitance.

The restoration function enabling portion 56b illustrated in FIG. 5 is provided with a low-pass filter (a delay circuit) constituted by a resistor R_{LPF} and a capacitor C_{LPF}. The low-pass filter is provided in order to adjust a time constant at which a gate voltage of the operation restoration switch Q7 changes from high to low as the switch Q3 is switched from ON to OFF and the switch Q4 is switched from OFF to ON when the low voltage abnormality occurs.

A case where the gate voltage of the operation restoration switch Q7 changes to low before the potential of the negative terminal 52 is changed to high is considered. In this case, since the potential of the negative terminal 52 is low (i.e., in a state before being changed to high), in the push-pull circuit of the external charge detector 56a, the switch Q5 is turned on, the switch Q6 is turned off, and the operation restoration switch Q7 is turned on. Although the FETs 55a and 55b of the cutoff portion 55 must be turned off due to the low voltage abnormality, the FETs 55a and 55b are in a state of not being able to be turned off. In view of the above, the time constant of the low-pass filter constituted by the resistor R_{LPF} and the capacitor C_{LPF} is set to be sufficiently longer than the time constant at which the potential of the negative terminal 52 changes from low to high.

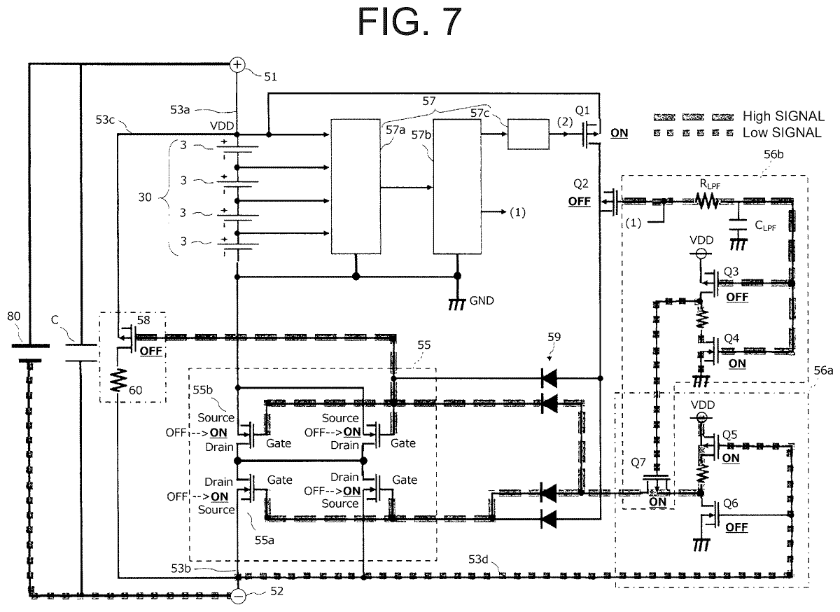

Next, a circuit operation of a case where a charger is connected when a low voltage abnormality has occurred will be described with reference to FIG. 7. When a charger 80 is connected to the positive terminal 51 and the negative terminal 52 of the energy storage apparatus that has been removed from the vehicle, the potential of the negative terminal 52 turns out to be a voltage represented as VDD-charger voltage. For example, when VDD is 10 V and the charger voltage is 14 V, the potential of the negative terminal 52 turns out to be −4 V (a GND reference of the BMU). Thus, the switch Q5 of the external charge detector 56a is turned on, and the switch Q6 is turned off. GND is input to the gate of the operation restoration switch Q7 and the operation restoration switch Q7 is already in a standby state. Therefore, when the switch Q5 is turned on, VDD is simultaneously input to the FETs 55a and 55b of the cutoff portion 55 via the operation restoration switch Q7 and the diodes 59, and the cutoff portion 55 is turned on.

In accordance with the flow as described above, after the power line has been cut off by the cutoff portion 55 due to a low voltage abnormality or a discharge overcurrent abnormality, the charger 80 (an external power supply) is connected to a battery terminal and the cutoff portion 55 is turned on again. In this way, restoring the operation of the energy storage apparatus is conducted.

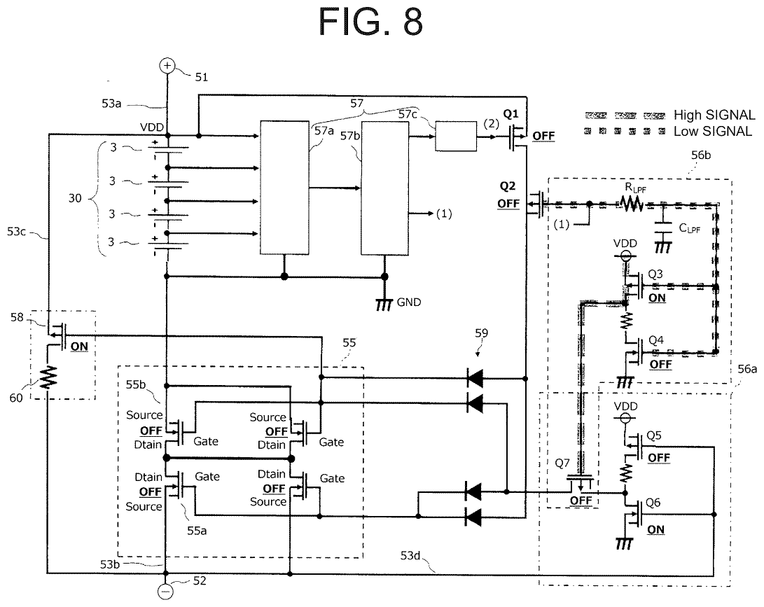

Next, a circuit operation of a case where an overcharge or a deep discharge has occurred in the energy storage apparatus and thus the energy storage apparatus is prohibited from being used again will be described with reference to FIG. 8. In this case, it is necessary to prevent the cutoff portion 55 from being turned on even if an external power supply such as a charger is connected to the battery terminal.

When the battery monitoring IC 57a detects an overcharge, the battery monitoring IC 57a outputs an overcharge abnormality signal to the cutoff control circuit 57b. The cutoff control circuit 57b outputs a low signal as the signal (1), and the latch circuit 57c latches a high signal output as the signal (2). As a result, the reuse prohibition switch Q1 and the cutoff control switch Q2 are turned off, the FETs 55a and 55b of the cutoff portion 55 are turned off, and moreover, the energy storage apparatus is prohibited from being used again.

At this time, the switch Q3 of the restoration function enabling portion 56b is turned on, the switch Q4 is turned off, and a high signal is input to the gate of the operation restoration switch Q7. When a high signal is input to the gate of the switch Q7, the switch Q7 cannot be turned on even if a charger is connected.

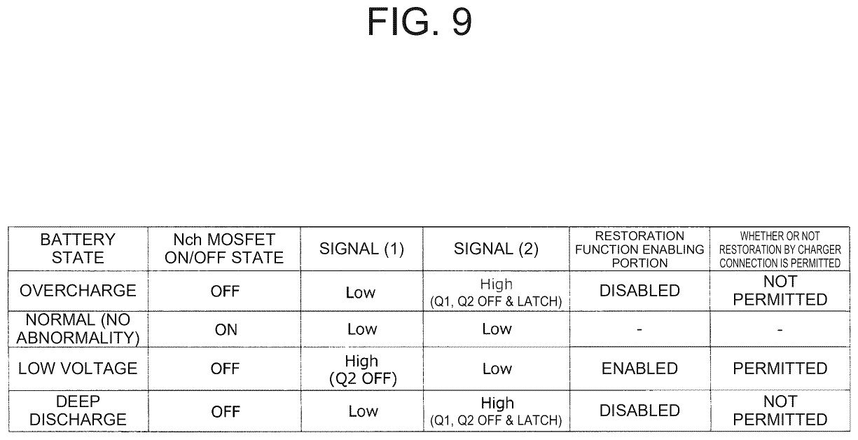

FIG. 9 summarizes the state of each portion when the energy storage apparatus is in each of the overcharge, normal (no abnormality), low voltage abnormality, and deep discharge states.

The present example embodiment is suitable for a system in which a semiconductor switch is mounted on a low side of an energy storage device. When the energy storage apparatus (battery) is required to have the function of executing cable communication with an external device (for example, a vehicle-side ECU), a GND potential of the BMU and a GND potential of the external device (equivalent to the potential of the negative terminal 52) must be the same potential. When the semiconductor switch is arranged on the low side and the semiconductor switch is turned off, the GND of the BMU and the negative terminal 52 corresponding to the GND of the external device are separated, and there is a possibility that normal communication cannot be performed. The battery 50 which is mounted on a motorcycle is not necessarily required to have the function of communicating with the vehicle-side ECU and the alternator 10B which serves as the vehicular battery charger. The present example embodiment is suitable for such an application.

The present example embodiment is also suitable for a case where the energy storage apparatus (battery) is required to have the function of executing wireless communication with the external device. This is because with the wireless communication, communication can be executed even if the GND potential of the management controller 53 and the GND potential of the external device are not the same potential.

The present invention is not limited to the example embodiments described above.

The battery 50 may be mounted on an electric motorcycle which does not have an engine, and may supply the electric power of 12 V to the auxiliary machines. Alternatively, the battery 50 may be mounted on an automobile having an engine, an electric vehicle (EV), a hybrid electric vehicle (HEV), or a plug-in hybrid electric vehicle (PHEV). The battery may be mounted on other movable bodies such as a flying object, a railroad train, or a ship. The rated voltage of the battery is not limited to 12 V, and may also be 48 V or other voltages within the so-called “low voltage” range.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device;
a management controller;
a positive terminal and a negative terminal;
a power line connecting the positive terminal, the energy storage device, and the negative terminal to each other;
a first semiconductor switch and a second semiconductor switch provided in series on the power line between the energy storage device and the negative terminal;
a cutoff control switch connected to the first and second semiconductor switches to simultaneously turn off the first and second semiconductor switches when an abnormality of the energy storage device is detected by the management controller; and
an external charge detector to simultaneously turn on the first and second semiconductor switches when detecting that an external power supply has been connected to the positive terminal and the negative terminal.

2. An energy storage apparatus comprising:
an energy storage device;
a management controller;
a positive terminal and a negative terminal;
a power line connecting the positive terminal, the energy storage device, and the negative terminal to each other;
a first semiconductor switch and a second semiconductor switch provided in series on the power line the energy storage device and the negative terminal;
a cutoff control switch connected to the first and second semiconductor switches to simultaneously turn off the first and second semiconductor switches when a first abnormality of the energy storage device is detected by the management controller;
a latch circuit; and
a reuse prohibition switch provided in series with the cutoff control switch to be turned off by the latch circuit when a second abnormality of the energy storage device is detected by the management controller, and to maintain an off state even when the second abnormality is resolved.

3. The energy storage apparatus according to claim 1, further comprising:
a wiring line provided in parallel with the power line to connect the power line, which is between the positive terminal and the energy storage device, and the negative terminal to each other; and
a third semiconductor switch on the wiring line.

4. The energy storage apparatus according to claim 3, wherein the external charge detector includes an operation restoration switch and a first push-pull circuit to which a potential of the negative terminal is input, and the operation restoration switch is switchable by an output of the first push-pull circuit to cause the first and second semiconductor switches to be simultaneously turned on.

5. The energy storage apparatus according to claim 4, further comprising a delay circuit to cause a timing at which the operation restoration switch is set to a standby state to be more delayed than a timing at which a potential of the negative terminal is pulled up.

6. The energy storage apparatus according to claim 4, further comprising a second push-pull circuit to which an output of a delay circuit is input, wherein the operation restoration switch is set to a standby state or switching of the operation restoration switch is prohibited depending on an output of the second push-pull circuit.

7. An energy storage apparatus comprising:
an energy storage device;
a management controller;
a positive terminal and a negative terminal;
a power line connecting the positive terminal, the energy storage device, and the negative terminal to each other;
a first semiconductor switch and a second semiconductor switch provided in series on the power line between the energy storage device and the negative terminal;
a cutoff control switch connected to the first and second semiconductor to switch and simultaneously turn off the first and second semiconductor switches when an abnormality of the energy storage device is detected by the management controller;
a latch circuit; and
a reuse prohibition switch provided in series with the cutoff control switch, to be turned off by the latch circuit when the abnormality of the energy storage device is detected by the management controller, and to maintain an off state even when the abnormality is resolved.
